(19) United States
(12) Patent Application Publication
(10) Pub. No.: US 2025/0318906 A1
(43) Pub. Date: Oct. 16, 2025

(54) METHOD AND APPARATUS FOR ORTHODONTIC TREATMENT

(71) Applicant: Orlin Valentinov ATANASOV, SOFIA (BG)

(72) Inventor: Orlin Valentinov ATANASOV, SOFIA (BG)

(21) Appl. No.: 18/865,101

(22) PCT Filed: May 23, 2023
(86) PCT No.: PCT/BG2023/000014

§ 371 Date: Nov. 12, 2024

(30) Foreign Application Priority Data
May 25, 2022 (BG) 113539

(51) Int. Cl. A61C 7/08

(52) U.S. Cl. CPC A61C 7/08

(57) ABSTRACT

The invention relates to a method and an individualized apparatus that can be used in orthodontic treatments, in particular for accelerating and synchronizing orthodontic treatments with dental aligners. A method of accelerating and synchronizing orthodontic treatment with dental aligners involves making an orthodontic setup by arranging the patient's teeth according to an individual malocclusion treatment plan, then making orthodontic appliances—aligners that are used together and simultaneously with an appliance for acceleration and synchronization, in the upper 2 and lower 3 channels of which the dental aligners 4 are placed, in which the synchronizing apparatus 1 is used together with the dental aligners for at least 60 minutes a day. The acceleration device 1 is a bus body, with shaped upper 2 and lower 3 channels, the dental aligners 4 are placed, and the channels 2 and 3have a depth that ensures full coverage of the dental crowns and gingiva.

### FIELD OF THE INVENTION

The invention consists of a method and a orthodontic appliance applicable to orthodontic treatments, in particular for accelerating and synchronizing orthodontic treatments with dental aligners.

### BACKGROUND OF THE INVENTION

Various methods, techniques, and appliances are known in dentistry and orthodontics for alignment of patients' teeth and improvement of the occlusion.

The physiological mechanism by which the movement of teeth takes place is sufficiently well known to the dental and orthodontic community and therefore does not need to be described here.

A method for orthodontic treatment is known in which, by means of standard, universally manufactured appliances—trainers, the dentist selects for the patient a suitable type of appliance according to the size, shape of the arch, construction and material. The trainer can be provided by a dental professional or purchased by the patient from a specialty store. The patients have to wear the appliance in the oral cavity mainly at night, as it significantly impairs speech, nutrition and normal lifestyle, predetermined by the fact that it covers both jaws at the same time. The patient makes regular visits to the dentist, who together with the patient decides at what point the desired result for straightening and aligning of the teeth is achieved.

An orthodontic treatment method is known and applied in the practice, in which individually made appliances—aligners are used. The application of this method begins with impressions of the patient's teeth and registration of the bite. Then a set of aligners is made, appropriately sized for the lower and upper jaw, respectively. The patient uses the aligners according to the previously prepared treatment plan and for the required period of time. The aligners for the lower and upper teeth correct their position, applying local forces in the respective jaw until the planned results are achieved.

In some cases, the dental practitioner may consider and suggest that it would be appropriate for the patient to use the two different methods alternately, using the different benefits of the two methods at different stages of treatment.

A detailed review of the prior technique in the field shows that at present, dentists can use successively the different methods, which have the corresponding advantages in different directions. It is pertinent to note that the simultaneous use of the known methods is currently impossible, mainly due to the fact that their joint use is ineffective in terms of achieving the desired result, as well as due to the significantly extended duration of the treatment.

Sequential application of orthodontic appliances is used to improve the occlusion and to arrange the dentition by the dental specialists. There are known types of appliances—trainers (MYO), which are universal, ie. they are made in certain size, construction and material. Removable orthodontic appliances are also known, with the help of which forces are applied in a controlled manner on the teeth and thus their gradual movement is achieved. As is known from orthodontic and dental practices, for the purposes of successful treatment with aligners, a mandatory condition is for them to be worn by the patient for at least 16-18 hours.

Patent publications EP 1802248 and EP 2182880 are known, which describe orthodontic appliances used to assist the alignment of teeth by applying corrective forces simultaneously to the lower and upper jaw. The patient receives a standard appliance according to the size of the dentition.

The appliance is one and covers both jaws at the same time, applying forces to the teeth. In general, this appliance (trainer) is used by patients mainly at night during sleep, because the appliance makes speech and nutrition impossible. The construction of the known appliances (trainers) is characterized with a body with U-shape and shaped grooves for both jaws, in accordance with universal arches, that correspond with the accepted forms in orthodontics.

In this form, the appliances of the type of trainers are insufficiently effective and can hardly be used for fast, precise and completely appropriate orthodontic treatment, tailored to the individual needs of each patient.

### SUMMARY OF THE INVENTION

In terms of the above and the prior art in the respective field, it is an object of the invention to provide a method for accelerating and synchronizing orthodontic treatments with dental aligners, as well as an appliance for orthodontic treatment with aligners to ensure effective synchronization of treatment and at the same time to speed up the treatment process while maintaining the parameters of the treatment plan, in particular to provide correction of the occlusion of the patients.

The method for accelerating and synchronizing the orthodontic treatment with dental aligners is performed using the clear aligners known in orthodontics, by initially taking conventional or digital impressions from the patient's teeth with bite registration, after which the impressions are subjected to virtual simulation to correct the alignment of the teeth and also the occlusion and on this basis motivational models are made, from which a set of orthodontic aligners are made, which are established by the treatment plan proposed to the patient.

The method according to the invention is applied by the simultaneous use of the orthodontic aligners and synchronization appliance, which covers both the lower and the upper jaw together with the aligners.

The appliance for accelerating and synchronizing the orthodontic treatment is made as a double splint, with an upper and lower groove corresponding to the shape and width of the arch, ensuring its tight fit to the properly arranged teeth with the orthodontic aligners placed on them. The grooves are designed as curvilinear surfaces tightly covering the curvilinear shapes of the outer surface of the aligners provided for the last phase of treatment. Thus, when the acceleration and synchronization appliance is used sequentially with the aligners from all phases of the treatment—FIG. 8, it takes the shape of the teeth from the current stage of treatment and applies additional forces in the relevant areas.

The acceleration and synchronization orthodontic appliance may be made of one or more types of materials. An important characteristic for the materials used are flexibility and elasticity, through which additional forces can be applied during the planned deformations. For the purpose of enhancing the effect of acceleration and synchronization, it is appropriate to use harder materials, especially in the occlusal area.

In the treatment of more specific or more severe orthodontic malocclusions, it may be necessary for one patient to divide the treatment into several main stages and to design several acceleration and synchronization appliances, respectively.

Dental aligners are made of a harder transparent material—PETG or a material with similar characteristics. The hardness and U-shape of the aligners reduces the forces caused by the elastic deformations of the acceleration and synchronization appliance and thus protect the teeth from excessive stress after reaching the set teeth displacement for the aligners of the current stage. Working in such synchrony, the aligners and the acceleration and synchronization appliance enable the dental professionals to align patients' teeth with full control of the applied of forces.

An additional positive effect is also obtained by clenching the teeth when the aligners and the acceleration and synchronization orthodontic appliance are placed. The upper and lower teeth apply additional forces to the opposite jaw in both directions, which leads to faster and synchronized correction of the occlusion, in the amount set in the treatment plan.

The acceleration and synchronization method and the appliance for its application provide effective orthodontic treatment, which is mainly due to the orthodontic appliance for acceleration and synchronization of orthodontic treatments with dental aligners. The invention makes it possible to accelerate orthodontic treatments, which is achieved by a controlled increase in the forces applied by the aligners required for orthodontic movements and provided by the synchronization appliance, which further increases the pressure on the teeth, especially at night or at home to reduce discomfort in the patients.

In addition to accelerating the achievement of planned movements, the acceleration and synchronization appliance provides and ensures synchrony in the correction of the occlusion in patients. In orthodontic treatments with aligners, side effects such as unforeseen expansions in the upper and lower jaw have been observed and proven. Very often, this expansion is positive for the occlusion of the patients, but unfortunately it is an effect that is so far uncontrollable due to the application of aligners separately in the upper and lower jaw. Due to many different factors during orthodontic treatment, the extent of expansion in the upper and lower jaw is different, which in many cases adversely affects the occlusion.

With the use of the synchronization appliance throughout the treatment with the provided set of aligners, dentists and orthodontists ensure that the movements in the lower and upper jaw are synchronized and no loss of proper occlusion due to uneven expansion will be observed. The reduction of the treatment time is achieved through the controlled application of additional forces.

The invention also helps to synchronize the treatment results in the upper and lower jaw by distributing the applied forces equally, thus improving the occlusion of the patient.

### BRIEF DESCRIPTION OF THE DRAWINGS

An exemplary embodiment of the method for accelerating and synchronizing orthodontic treatment with dental aligners and an orthodontic appliance for its application is presented in more detail with the help of the accompanying drawings, where:

FIG. 1—general visualizations

FIG. 2—unfolded, vertical diagram of the method of acceleration and synchronization

FIG. 3—axonometric view of the appliance for acceleration and synchronization

FIG. 4—cross section of the orthodontic appliance on FIG. 2

FIG. 5—top view of an appliance for acceleration and synchronization of treatment with and without dental aligners in the groove

FIG. 6—bottom view of the appliance for acceleration and synchronization of treatment with and without dental aligners in the groove

FIG. 7—visualization of another embodiment of an orthodontic appliance for acceleration and synchronization

FIG. 8—visualization of the forces applied by the aligners and the appliance for acceleration and synchronization before, during and after the achievement of the stage movements set in the aligners

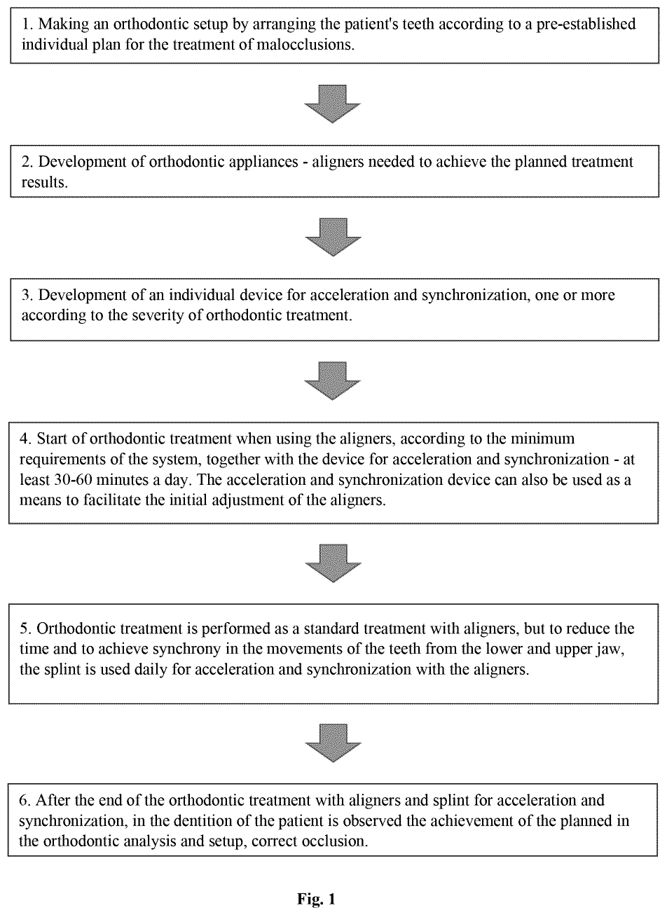

### PRIMERY EMBODIMENT OF THE INVENTION

Hereinafter, an exemplary embodiment of the method for accelerating and synchronizing orthodontic treatment with dental aligners is presented, the described sequence of operations and their characteristic parameters being applied in various embodiments and modifications using variant embodiments of the orthodontic appliance for accelerating and synchronizing orthodontic treatment, has an equivalent action or functional purpose and provides the described beneficial effect of using the method.

In this sense, the exemplary implementation of the method should be considered and interpreted to illustrate the idea of the proposed technical solution—a method and orthodontic appliance for accelerating and synchronizing orthodontic treatment, which does not limit the use of other alternative embodiments. Aspects of the present invention have been described in connection with the application of the method according to the embodiments of the invention.

The following description is provided to enable any person skilled in the field to make and use the embodiments and is provided in the context of a particular application and its requirements. The general principles defined herein may be applied to other embodiments and applications without departing from the spirit and scope of the present embodiments. Thus, the various embodiments must be given the widest range in accordance with the principles and characteristics disclosed herein. Although the present invention has been disclosed by reference to preferred embodiments and examples, it should be understood that these examples are intended to be illustrative and not restrictive.

The method according to the invention is carried out in the following sequence: orthodontic setup is applied by aligning the patient's teeth according to a pre-established plan for treatment of malocclusions, followed by orthodontic appliances—aligners necessary to achieve the planned treatment goals.

After the aligners, an individual appliance for acceleration and synchronization is developed. Depending on the severity of the orthodontic treatment for the patient, more appliances can be prepared in accordance with the treatment plan.

The beginning of the orthodontic treatment itself starts with the simultaneous use of the aligners, together with the appliance for acceleration and synchronization, and the combined use of the two appliances—aligners and the appliance for acceleration must be a minimum of 60 minutes per day and a maximum of the full time of wearing the aligners. The acceleration and synchronization appliance also has the function of a means to facilitate the initial adjustment of the aligners.

The orthodontic treatment is performed as a standard treatment with aligners, but in order to reduce the time and to achieve synchrony in the movements of the teeth from the lower and upper jaw, the splint has to be used daily for acceleration and synchronization together with the aligners. After the end of the orthodontic treatment with aligners and the appliance for acceleration and synchronization, in the dentition of the patient, the planned in the orthodontic analysis and setup—correct occlusion and arrangement of the teeth, is achieved.

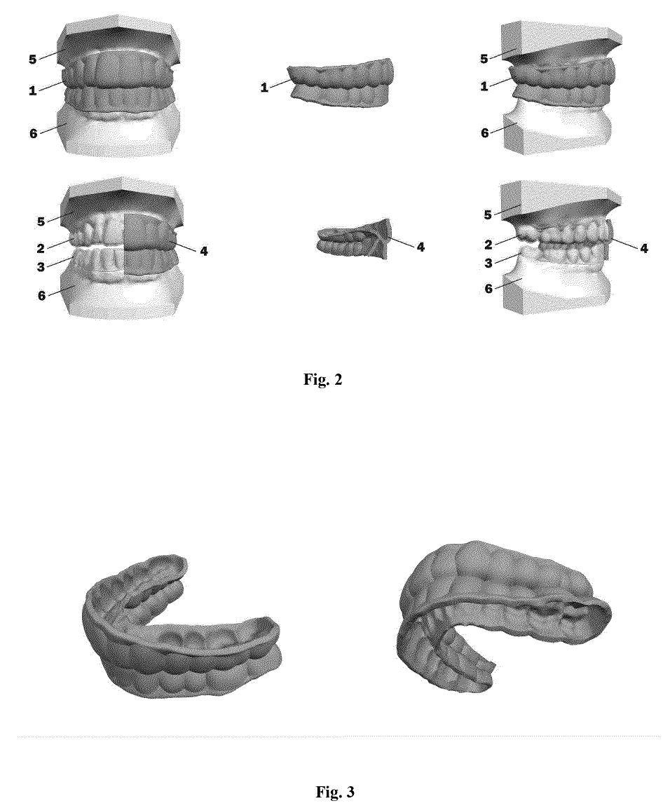

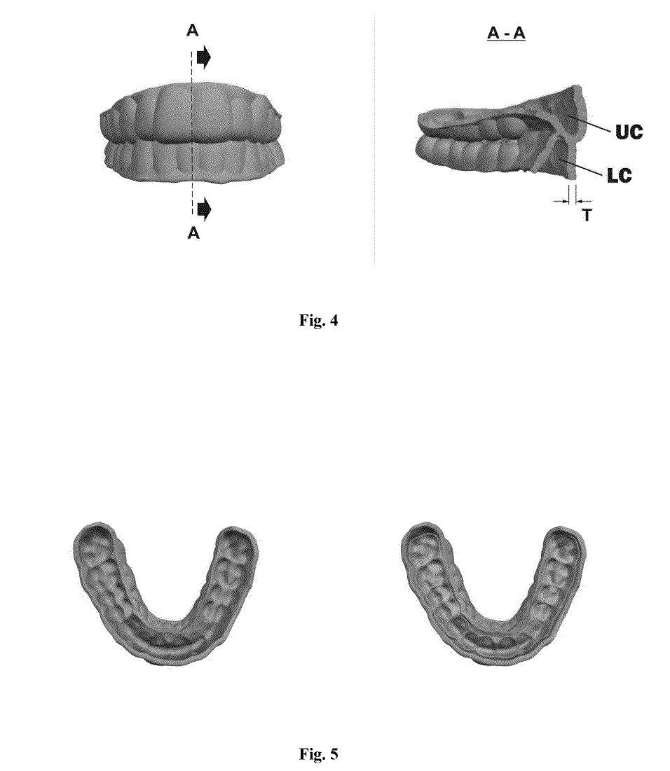

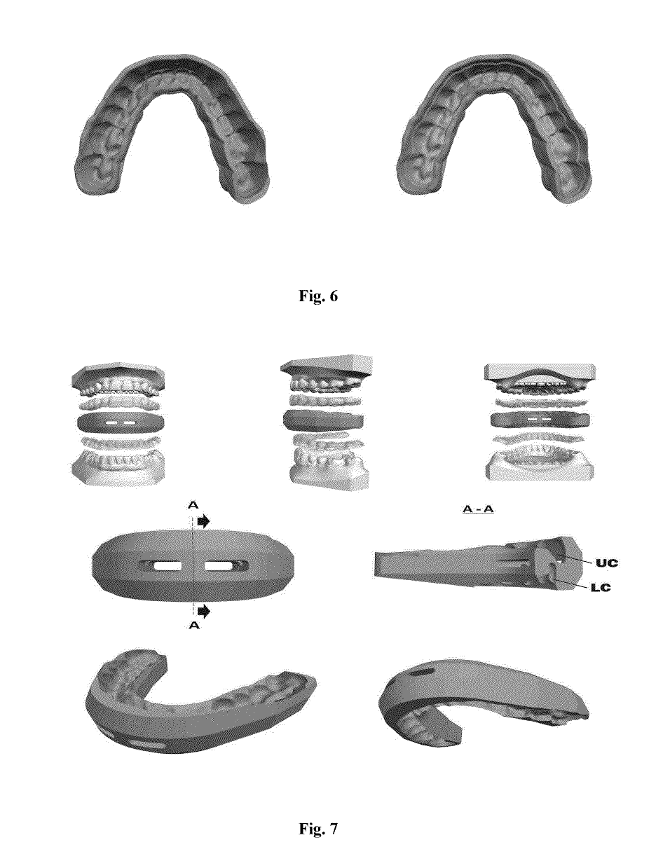

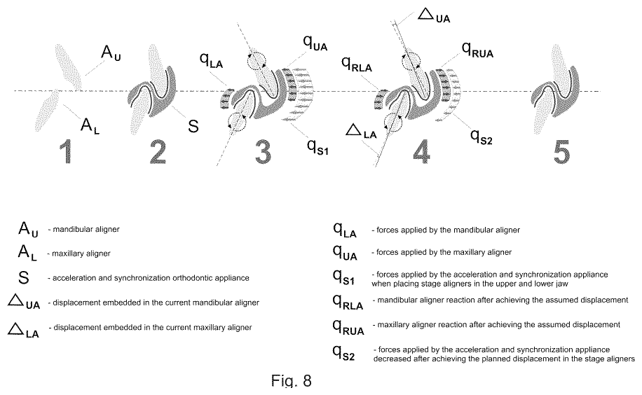

The acceleration and synchronization method is applied by means of the acceleration and synchronization appliance 1 shown in detail in FIG. 2. The acceleration and synchronization appliance is a double splint with symmetrically shaped grooves 2 and 3 for the upper and lower jaw, respectively. Grooves 2 and 3 are U-shaped, and their exact shape is obtained by subtracting from the volume of the acceleration and synchronization appliance the exact volumes and shapes, respectively of the upper and lower jaw, in a position where the teeth are arranged together with the aligners on them. The thickness T (FIG. 4) of the walls of the acceleration appliance 1 should not be less than 0.1 mm.

The grooves 2 and 3 for the teeth of the upper jaw, together with the dental aligners, have a minimum depth of 4 mm, reaching full coverage of the dental crowns and the marginal gingiva. The depth of the grooves 2 and 3 is determined so as to ensure coverage of the patient's lower and upper jaw, together with the aligners adjusted on the teeth at once.

The acceleration and synchronization appliance 1 is made based on the models of the teeth shown in the figures, which are essentially a simulation of the correctly arranged teeth of the patient, ie. ‘Motivation models’ that can be made of different materials (gypsum, PVC, resins, etc.). The orthodontic appliance 1 can be manufactured both by known thermo-forming machines and by digitized individual design.

According to a preferred embodiment of the invention, the acceleration and synchronization appliance is made of ethylene vinyl acetate or a material with similar characteristics.

According to an embodiment of the orthodontic appliance 1, it is suitable to provide breathing openings in the body along the entire length of the arch. An alternative embodiment is possible in which the breathing openings are formed only in the front part of the body of the appliance 1 and are arranged in a wavy pattern.

The patient is advised to use the acceleration and synchronization appliance 1 together with the sets of aligners, designed for his treatment. It is recommended to use the appliance longer on average daily, which provides better and optimal results in terms of accelerating and synchronizing the planned treatment with aligners.

The aligners are used according to the instructions of the system and their manufacturer, and the acceleration and synchronization appliance 1 must be used together with the aligners for at least 60 minutes a day. The patient is recommended to use the appliance for a longer time on average, which provides better results.

The acceleration and synchronization appliance stimulates faster controlled movement of the teeth, which allows a reduction in the number of aligners used and speeds up the periods of replacement of the aligners with the next ones provided. The acceleration and synchronization appliance also facilitates the initial adjustment of each new set of aligners, which reduces the time of the patient in the dental office and makes it possible to conduct remote orthodontic treatment.

1. Method for accelerating and synchronizing orthodontic treatment with dental aligners with the following characteristics: the dental aligners are used together and simultaneously with an acceleration and synchronization appliance, in which the dental aligners are placed in the upper 2 and lower 3 grooves, and thus the appliance for synchronization 1 is used together with the dental aligners for at least 60 minutes a day.

2. Method according to claim 1, characterized in that the acceleration appliance (1) is individual and is made in accordance with the arranged orthodontic setup and the motivational models of the patient.

3. Method according to claim 1, characterized in that according to the treatment plan of the patient during the orthodontic treatment with dental aligners more than one appliance for acceleration and synchronization is used/1/, according to the type and characteristics of the orthodontic malocclusions/1/.

4. Orthodontic appliance for acceleration and synchronization, consisting of a double splint with grooves for the upper and lower jaw, characterized in that the groove for the upper jaw/2/ and for the lower jaw/3/ are U-shaped, as the minimum depth of the grooves/2,3/ is 4 mm, providing full coverage of the dental crowns and gingiva, and the thickness T of the walls of the acceleration/1/ is at least 0.1-0.35 mm and is determined according to the individual characteristics of the patient.

5. Orthodontic appliance according to claim 4, characterized in that it is made of ethylene vinyl acetate or a material with similar characteristics.

6. Orthodontic appliance according to claim 4, characterized in that it is made by thermo-forming technology.

7. Orthodontic appliance according to claim 4, characterized in that it is made by digitized construction.

8. Orthodontic appliance according to claim 5, characterized in that holes are formed in the body of the appliance (1) located along the entire length of the arc.

9. Appliance according to claim 5, characterized in that the appliance (1) is made of a two-component material, the front (central) part of the arc being made of a material with a higher stiffness than the material with which the peripheral segments of the arc are made.
